(19) United States
(12) Patent Application Publication
(10) Pub. No.: US 2008/0005419 A1
(43) Pub. Date: Jan. 3, 2008

(54) System and method for learning including a book with a USB connector

(76) Inventor: Donald Spector, New York, NY (US)

Correspondence Address: DIEHL SERVILLA LLC, 77 BRANT AVE, SUITE 210, CLARK, NJ, 07066, US

(21) Appl. No.: 11/440,934

(22) Filed: May 25, 2006

(51) Int. Cl. G06F 13/38

(52) U.S. Cl. 710/62

(57) ABSTRACT

A book with a USB connection is provided. The book also has a memory and optionally a processor. One or more documents are stored in the memory. When the book is connected to a personal computer, the documents can be displayed on the personal computer. The documents can be modified and stored on the memory in the book for later use by the book's owner. A server can also be connected to the personal computer and the progress of a plurality of students with books can be monitored. Educational systems and methods are also disclosed.

### FIELD OF THE INVENTION

This application relates to the field of books and to educational systems and methods.

### BACKGROUND OF THE INVENTION

Learning from a text book can be difficult and limiting. People learn through different mechanisms. Some people simply read and remember, others need to take copious notes from a text book to learn. Others learn better through visual and pictorial presentations of information. A simple text book does not offer a full range of teaching mechanisms that can be helpful to students. Also, it can be difficult to organize all of the additional references or information obtained from sources other than the textbook.

Long distance educational systems and methods can also be difficult to implement. It is difficult to track the progress of various students.

Accordingly, new and improved books and educational systems and methods are needed.

### DESCRIPTION OF THE DRAWINGS

FIG. 1 illustrates a book and an educational system in accordance with one aspect of the present invention.

FIG. 2 illustrates a circuit on a book in accordance with an aspect of the present invention.

FIG. 3 illustrates a plurality of documents stored on a memory on the book in accordance with a further aspect of the present invention.

FIG. 4 illustrates a roster of students used to monitor the progress of students at a server in accordance with an aspect of the present invention.

FIG. 5 illustrates another circuit that can be located on a book in accordance with a further aspect of the present invention.

### SUMMARY OF THE INVENTION

One aspect of the present invention is an article that includes a book, a memory on the book and a connector on the book electronically connected to the memory and capable of providing an interface to a computer.

In accordance with another aspect of the present invention, the connector is a USB connector. In accordance with a further aspect of the present invention, the book has a spine and the USB connector is on the spine.

In accordance with yet another aspect of the present invention, one or more documents related to the contents of the book are stored in the memory. The documents include a worksheet related to the book, problems related to the book and/or notes related to the book. The notes can be generated by a user.

In accordance with a further aspect of the present invention, the book also includes a processor connected to the memory and the connector.

The present invention also contemplates an application being stored on the memory and is operable on the processor to instruct a personal computer.

The present invention also contemplates an educational system that includes a personal computer and a book having a memory and a connector capable of being connected to the personal computer, with one or more documents stored on the memory. When the book is connected to the personal computer through the connector, the one or more documents are transferred from the memory to the personal computer.

In accordance with another aspect of the present invention, an object from the personal computer can be stored on the memory on the book. The object can be a modified version of one of the one or more documents.

The one or more documents can be selected from the group consisting of: worksheets, problems, notes generated by a user, and/or combinations thereof.

In accordance with further aspects of the invention, the system further includes a server connected to the personal computer, wherein the personal computer can transfer the one or more documents to the server and the server monitors a user's progress through the book. The server can also transfer the one or more documents to the personal computer.

The present invention also contemplates an educational method that includes the steps of transferring a document from a book to a personal computer, transferring the document form the personal computer to a server and monitoring a user's progress through the book at the server based on the document. The documents can be selected from the group consisting of: worksheets, problems and notes generated by a user. The present invention also includes transferring a modified version of the document from the personal computer to the book.

### DESCRIPTION OF A PREFERRED EMBODIMENT

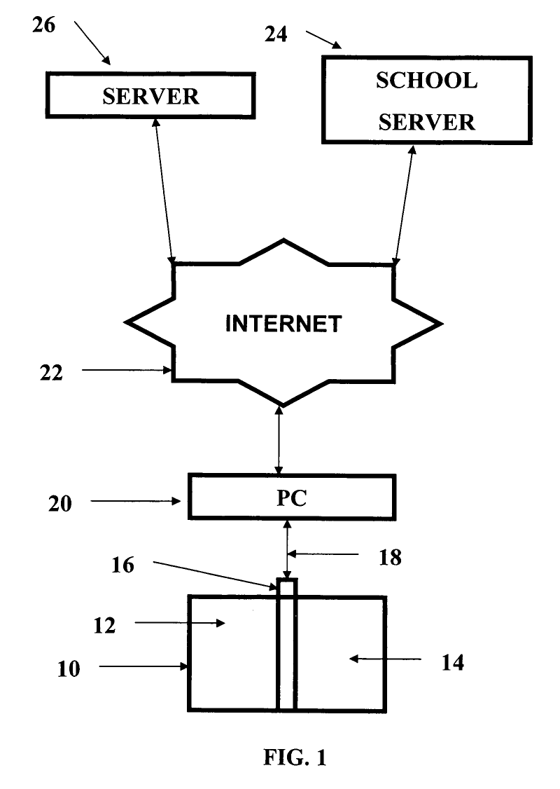

FIG. 1 illustrates an education system. The system includes a book 10 having a left side 12, a right side 14 and a spine 15. A connector 16 is attached to the book 10, preferably on the spine 15 of the book 10, although it can be attached anywhere on the book 10.

The connector 16 is preferably a USB connector.

A cable 18 can connect the book 10 to a personal computer 20. The personal computer 20 is connected to a network, such as the internet 22. A plurality of servers 26 are connected to the internet 22. A school's server 24 is also connected to the internet 22. Thus, the servers 24 and 26 are connected to the book 10 through the internet 22 and the personal computer 20.

Any type of connector 16 can be used. For example, the connector 16 can be a wireless transceiver that connects to a personal computer 20. While the connection—by wire or wireless—can be made directly to the personal computer 20, it can also connect to another personal computer via the internet 22 or to any server 26 on the internet.

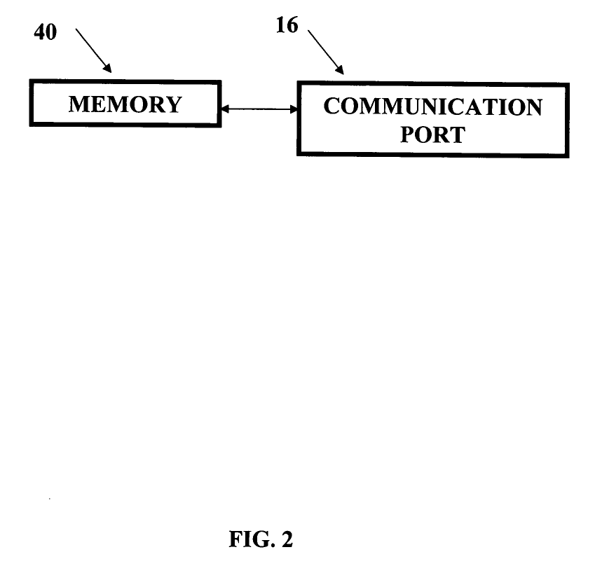

FIG. 2 illustrates a circuit that is located on the book 10 in accordance with one aspect of the present invention. The book 10 preferably has a memory 40 that is connected to a connector or communication port 16. In accordance with one aspect of the present invention, one or more documents related to the contents of the book are stored in the memory 40.

The memory 40 can also be located on the spine 15 of the book 10. The memory 49 and the connector 16 can be attached by an adhesive or by other means. For example, the memory 40 and the connector 16 can be attached inside a cover of the book 10 by adhesive. The can also be attached to a special page or to an insert during the manufacturing process.

The one or more documents can include a worksheet related to the book 10. They can also include problems related to the book. They can also include notes related to the book. Typically, the notes are generated by a user on a personal computer 20 when the user is reading the book or other sources and the notes can be stored on the memory 40 of the book 10. The notes can be stored as a template in the memory 40 for use by a user.

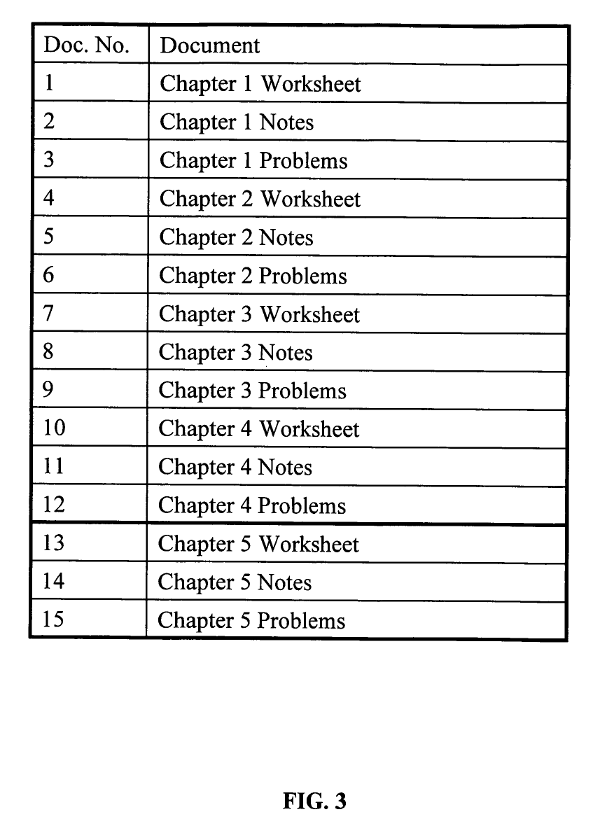

An example of the one or more documents stored on the memory 40 is illustrated in FIG. 3. There are fifteen documents stored on the memory. The first document is a worksheet based on the contents of chapter 1 in the book 10. The worksheet is a programmed review of the contents of chapter 1. The second document is notes from chapter 1 of the book 10. The document can be a blank document or it can be in template form. The notes document can be modified by a user, typically on the personal computer 20 and then stored on the memory 40 of the book 10 in a modified form. The third documents are problems related to the contents of chapter 1 of the book 10. Documents 4 to 15 are similar documents relating to chapters 2 to 5 of the book 10.

The documents from the memory 40 on the book 10 can be used, manipulated and modified by an owner of the book 10 while studying the book. Typically, the owner would use the documents on the personal computer 20 and store the documents, as modified, on the memory 40 in the book 10.

The documents can also be sent by the personal computer 20 to the school server 24 once they are completed by an owner of the book 10. The school server 24 can check on the progress of the book owner. If the book owner is a student in a class at the school, the school can conduct effective long distance learning by checking the progress of the book owner.

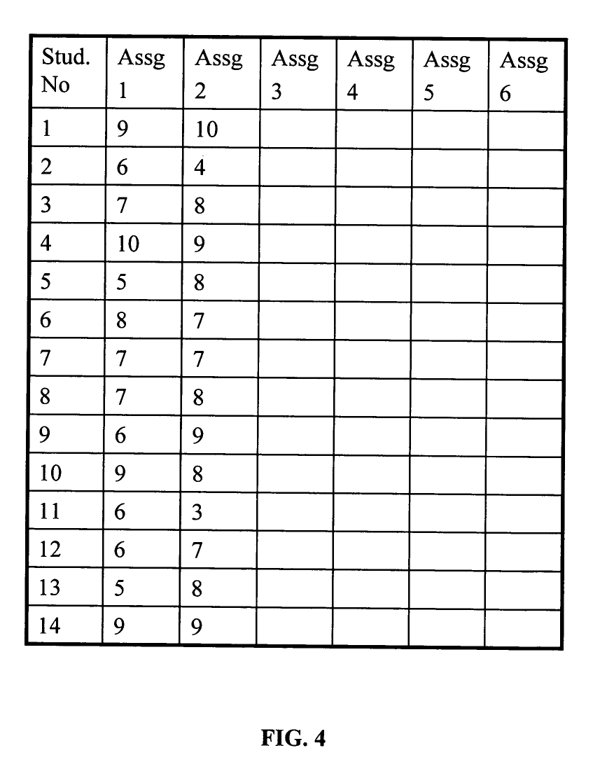

FIG. 4 illustrates a database maintained by the school server 24. The school server 24 can track the progress of a number of students in accordance with the present invention. In FIG. 4, there are fourteen students being tracked. During a semester, there will be six assignments, which could include homework, tests, worksheets, problem sets and the like. The first two assignments have been completed and every student has submitted a document through a personal computer 20 to the school server 24. Grades have been entered into the database of FIG. 4 for each student for each of the first two assignments. In this fashion, the progress of the students can be tracked by the school server 24.

The school server 24 can also submit documents to be stored on the memory 40 of the book 10. The server 24 would typically first transmit the documents to the personal computer 20, which would then transmit the documents to the memory 40 on the book 10. These documents could be comments from a teacher, progress reports or other communications to the student or owner of the book 10.

The owner of the book 10 can also connect to other servers 26 via the internet 22 to obtain further information about the subject of the book 10. The memory 40 may include a listing of sites and a link to those sites so that the book owner can easily access the sites by clicking on a document that has been transmitted from the memory 40 on the book 10 to the personal computer 20. The documents from various servers 26 can also be stored on the memory 40 of the book 10.

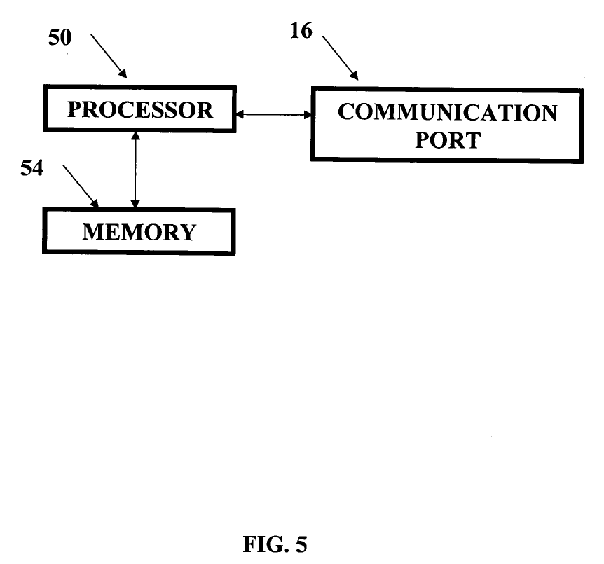

FIG. 5 illustrates another embodiment of a circuit that may be found on the book 10. This circuit includes the communication port 16 which is preferably a USB port. It also includes a processor 50 connected to the port 16 and a memory 54 connected to the processor 50. The memory 54 can store the previously referred to documents. It can also store application software that can be accessed by the processor 50. The application software can be downloaded to the personal computer 20 or processed by the processor 50. The memory 40 from FIG. 2 can also hold application software that can be downloaded to the personal computer 20.

The processor 50 is preferably located near the memory 54 and the connector 16. These components can be located in the same places as previously discussed with respect to the memory 40.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. An article, comprising:
a book;
a memory on the book; and
a connector on the book electronically connected to the memory and capable of providing an interface to a computer.

2. The article of claim 1, wherein the connector is a USB connector.

3. The article of claim 1, wherein the connector is a wireless transceiver.

4. The article of claim 1, wherein the book has a spine and the connector is on the spine.

5. The article of claim 1, wherein the connector and memory is on a page in or on a cover of the book.

6. The article of claim 1, wherein one or more documents related to the contents of the book are stored in the memory.

7. The article of claim 6, wherein at least some of the one or more documents includes a worksheet related to the book.

8. The article of claim 6, wherein at least some of the one or more documents includes problems related to the book.

9. The article of claim 6, wherein at least some of the one or more documents includes notes related to the book.

10. The article of claim 9, wherein the notes are generated by a user.

11. The article of claim 1, further comprising a processor connected to the memory and the connector.

12. The article of claim 11, wherein an application is stored on the memory and is operable on the processor to instruct a personal computer.

13. An educational system, comprising:
a personal computer; and
a book having a memory and a connector capable of being connected to the personal computer, one or more documents stored on the memory;
wherein when the book is connected to the personal computer through the connector, the one or more documents is transferred from the memory to the personal computer.

14. The system of claim 13, wherein an object from the personal computer can be stored on the memory on the book.

15. The system of claim 14, wherein the object is a modified version of one of the one or more documents.

16. The system of claim 13, wherein the one or more documents are selected from the group consisting of: worksheets, problems and notes generated by a user.

17. The system of claim 13, further comprising:
a server connected to the personal computer;
wherein the personal computer can transfer the one or more documents to the server and the server monitors a user's progress through the book.

18. The system of claim 17, wherein the server can transfer the one or more documents to the personal computer.

19. An educational method, comprising:
transferring a document from a book to a personal computer;
transferring the document from the personal computer to a server; and
monitoring a user's progress through the book at the server based on the document.

20. The method of claim 19, wherein the one or more documents are selected from the group consisting of: worksheets, problems and notes generated by a user.

21. The method of claim 19, further comprising transferring a modified version of the document from the personal computer to the book.
